(19) United States
(12) Patent Application Publication
(10) Pub. No.: US 2007/0179640 A1
(43) Pub. Date: Aug. 2, 2007

(54) Environmental monitoring system for a machine environment

(75) Inventor: Eric Alan Moughler, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/342,567

(22) Filed: Jan. 31, 2006

(51) Int. Cl. G05B 13/02

(52) U.S. Cl. 700/36

(57) ABSTRACT

Systems and methods for managing a machine environment based on environmental conditions associated with a machine are disclosed. According to one embodiment, the method may include receiving one or more of environmental data and operation data associated with at least one machine operating at a job site associated with a machine environment. An aspect may also include determining one or more environmental conditions associated with the job site based on at least one of the environmental data and the operation data. An aspect may further include updating a project schedule based on the determined environmental conditions.

### Technical Field

The present disclosure relates generally to data monitoring systems and, more particularly, to an environmental monitoring system for a machine environment.

### BACKGROUND

project management is an important aspect in any cost-conscious business environment, particularly those in which productivity is contingent upon external environmental conditions such as weather, terrain conditions, and temperature. Certain industries, such as mining, construction, farming, and energy exploration, may rely on the deployment of equipment resources across multiple job sites spanning large geographical areas within the same project environment. Typically, project managers are deployed at each job site to monitor the environmental conditions and schedule certain tasks according to the current and/or forecasted environmental conditions associated with their respective site. However, deploying project managers to each job site associated with a project may be costly and inefficient. Furthermore, improper and/or inadequate forecasting of environmental conditions may lead to inefficient management of equipment resources and/or damage to the equipment resulting from improper operation of the equipment in non-ideal environmental conditions. Thus, in order to manage a machine environment, a system for accurately determining environmental conditions associated with a job site may be required.

One method for scheduling work tasks based on weather forecast information is described in U.S. patent No. 6,643,582 (“the '582 patent) to Adachi et al. The '582 patent describes a work management system that calculates the weather forecast for a particular job site based on the position of a machine. The system may then update a work schedule chart based on the calculated weather forecast. The system of the '582 patent may also include a soil quality calculator that calculates the soil quality at the site based on the position of the machine. An attachment calculator may then determine the size and type of attachment for the machine based on the calculated soil quality at the job site.

Although the '582 patent may provide an automated system that adjusts a work schedule of a machine from weather forecast information, it may still be inadequate in certain aspects. For example, because the system of the '582 patent determines the weather forecast based on information gathered from public information sources (e.g., the Internet), without regard to actual environmental data received from the machine, it may not accurately detect rapid changes in weather due to the potential time delays in updating and retrieving the information.

In addition, because the system of the '582 patent cannot collect real-time environmental data associated with the machine, it may be unreliable. For instance, should weather forecast information indicate that the conditions are appropriate for operation of a machine while actual environmental conditions suggest the contrary, the system of the '582 patent may incorrectly schedule the machine for operation. As a result, projects that rely on operation of equipment resources at full (or nearly full) productivity may become inefficient, resulting in costly and unnecessary project delays.

Furthermore, the system of the '582 patent cannot calculate environmental conditions of a machine based on the operational characteristics of the machine. Instead, the system of the '582 patent may only retrieve environmental information from an external source (e.g., the Internet, local or national weather broadcasts, etc.) based on a machine position. Consequently, certain environmental data that may not be provided by external sources (e.g., soil density, traction, etc.), may not be accounted for by the system of the '582 patent.

The disclosed environmental monitoring system for job-site management is directed towards overcoming one or more of the problems set forth above.

### SUMMARY OF THE INVENTION

In accordance with one aspect, the present disclosure is directed toward a method for managing a machine environment based on environmental conditions associated with a machine. The method may include receiving one or more of environmental data and operation data associated with at least one machine operating at a job site associated with a machine environment. The method may also include determining one or more environmental conditions associated with the job site based on at least one of the environmental data and the operation data. The method may further include updating a project schedule based on the determined environmental conditions.

According to another aspect, the present disclosure is directed toward a computer readable medium for use on a computer system, the computer readable medium having computer executable instructions for performing a method for managing a machine environment based on environmental conditions associated with a machine. The method may include receiving one or more of environmental data and operation data associated with at least one machine operating at a job site associated with a machine environment. The method may also include determining one or more environmental conditions associated with the job site based on at least one of the environmental data and the operation data. The method may further include updating a project schedule based on the determined environmental conditions.

In accordance with another aspect, the present disclosure is directed toward a machine environment. The machine environment may include at least one machine for performing a task associated with the machine environment and including one or more monitoring devices configured to collect data indicative of at least one of environmental data and operation data associated with the at least one machine. The machine environment may also include an environmental monitoring system communicatively coupled to the one or more machines via a communication network, the environmental monitoring system including a processor. The processor may be configured to receive one or more of environmental data and operation data associated with at least one machine operating at a job site associated with a machine environment. The processor may also be configured to determine one or more environmental conditions associated with the job site based on at least one of the environmental data and the operation data. The processor may be further configured to update a project schedule based on the determined environmental conditions.

### BRIEF DESCRIPTION OF THE DRAWINGS

FIG. 1 provides a diagrammatic illustration of a machine environment according to an exemplary disclosed embodiment;

FIG. 2 provides a schematic illustration of an exemplary disclosed machine environment 100 according to an exemplary disclosed embodiment;

FIG. 3 provides a flow diagram of an exemplary project management method according to an exemplary disclosed embodiment; and

FIG. 4 provides a flow diagram of an exemplary disclosed method for evaluating a work assignment based on one or more environmental conditions.

### DETAILED DESCRIPTION

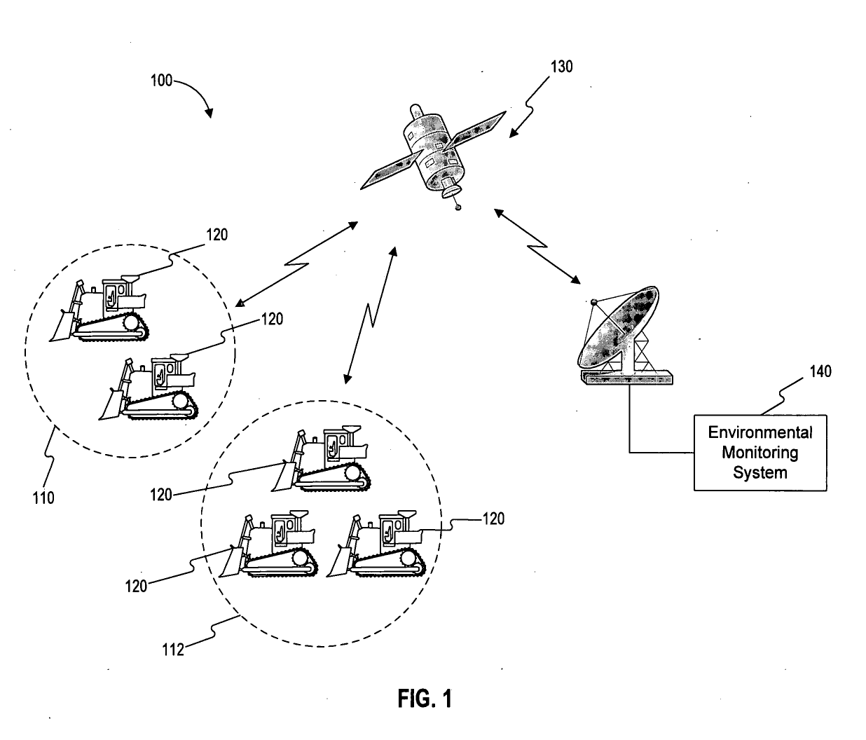

FIG. 1 provides a diagrammatic illustration of an exemplary disclosed machine environment 100. Machine environment 100 may include any environment in which one or more machines 120 operate to perform a task associated with an industry such as mining, construction, farming, transportation, energy exploration or other type of industry. For example, machine environment 100 may include one or more construction sites in which one or more machines 120 cooperate to perform a task associated with the completion of a construction project.

Machine environment 100 may include one or more machines 120, an environmental monitoring system 140, and a communication network 130 for providing data communication between one or more machines 120 and environmental monitoring system 140. Machine environment 100 may include additional, fewer, and/or different components than those listed above.

Machines 120 may include any type of equipment configured to perform a task associated with machine environment 100. For example, machines 120 may include a mobile or stationary machine such as, for example, an earth-moving machine, an on-highway vehicle, a generator set, an engine system, or any other machine operable to perform a task associated with machine environment 100. Furthermore, although FIG. 1 illustrates machines 120 as track-type tractor machines, each of machines 120 may be any type of machine operable to perform a particular function within machine environment 100. Furthermore, it is contemplated that machines 120 may be grouped into one or more machine sets 110, 112 for associating the operations of particular machines to groups of machines. Furthermore, it is also contemplated that machine sets 110, 112 may be located in a common work site or, alternatively, in separate work sites spaced apart from one another geographically. Additionally, machine sets 110, 112 may be located in a position geographically spaced from environmental monitoring system 140.

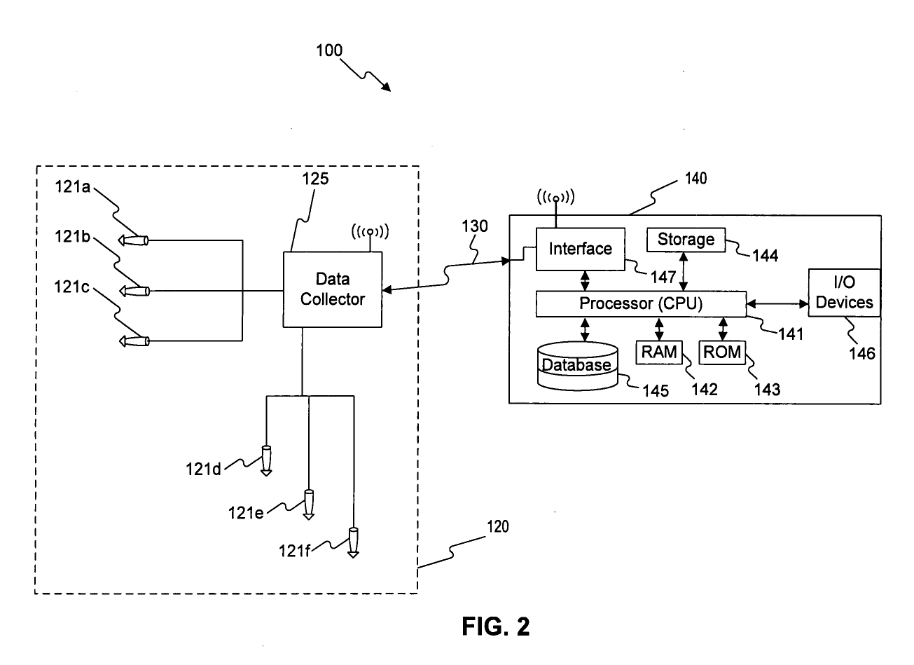

As shown in FIG. 2, each of machines 120 may include on-board data collection and communication equipment to monitor, collect, and/or transmit information associated with an operation of one or more components of machines 120. For example, machines 120 may each include, among other things, one or more monitoring devices 121a-f communicatively coupled to one or more data collection devices 125. Each of machines 120 may also be configured to receive information from off-board systems, such as an environmental monitoring system 140 via communication network 130. The components described above are exemplary and not intended to be limiting. Accordingly, the disclosed embodiments contemplate each of machines 120 including additional and/or different components than those listed above.

Monitoring devices 121a-f may include any component for collecting environmental and/or operation data associated with one or more machines 120 and/or machine environment 100. For example, monitoring devices 121a-f may include one or more sensors for measuring an environmental parameter such as, for example, air temperature, barometric pressure, moisture level, relative humidity level, UV index, precipitation level and type, wind speed, soil moisture level, or any other environmental parameter. Alternatively and/or additionally, monitoring devices 121a-f may include one or more sensors for measuring an operational parameter such as, for example, engine and/or machine speed and/or location; fluid pressure, flow rate, temperature, contamination level, and or viscosity of a fluid; electric current and/or voltage levels; fluids (i.e., fuel, oil, etc.) consumption rates; loading levels (i.e., payload value, percent of maximum payload limit, payload history, payload distribution, etc.); transmission output ratio, slip, etc.; grade; traction data; scheduled or performed maintenance and/or repair operations; and any other such operation data. It is contemplated that monitoring devices 121a-f may include a first array of sensors 121a-c dedicated to the collection of environmental data and a second array of sensors 121e-f dedicated to the collected of operation data.

Data collection device 125 may be communicatively coupled to each of data monitoring devices 121a-f and environmental monitoring system 140 and configured to collect and distribute data associated with machine 110. For example, data collection device 125 may receive environmental and/or operation data associated with machine 120 from data monitoring devices 121a-f and provide the received data to environmental monitoring system 140 via communication network 130. Data collection device 125 may embody a standalone unit for providing data collection and distribution for machine 120. Alternatively data collection device 125 may be included as part of an integrated control unit, such as an electronic control module (ECM) or other device associated with machine 120.

Communication network 130 may include any components that provide communication between each of machines 120 and an off-board system, such as environmental monitoring system 140. For example, communication network 130 may communicatively couple machines 120 to environmental monitoring system 140 across a wireless networking platform such as, for example, a satellite communication system. Alternatively and/or additionally, communication network 130 may include one or more broadband communication platforms appropriate for communicatively coupling one or more machines 120 to environmental monitoring system 140 such as, for example, cellular, Bluetooth, microwave, point-to-point wireless, point-to-multipoint wireless, multipoint-to-multipoint wireless, or any other appropriate communication platform for networking a number of components. Although communication network 130 is described as a wireless communication network, it is contemplated that communication network 130 may include wireline networks such as, for example, Ethernet, fiber optic, waveguide, or any other type of wired communication network.

Environmental monitoring system 140 may include any means for collecting, analyzing, monitoring, storing, reporting, processing, and/or communicating data. For example, environmental monitoring system 140 may include a central processing unit (CPU) 141, a random access memory (RAM) 142, a read only memory (ROM) 143, a storage 144, a database 145, I/O devices 146, a network interface 147, etc. Environmental monitoring system 140 may be configured to execute and run software programs that collect, analyze, store, transmit, organize, and monitor various data associated with machine 100.

CPU 141 may include one or more processors that can execute instructions and process data to perform one or more functions associated with environmental monitoring system 140. For instance, CPU 141 may execute software that enables environmental monitoring system 140 to request and/or receive operation and/or environmental data from one or more machines 120. CPU 141 may also execute software that enables environmental monitoring system 140 to determine one or more environmental conditions at a job site based on the received environmental data and/or operation data associated with one or more machines 120. CPU 141 may also execute software that schedule tasks and/or work assignments associated with one or more machines 120 and/or machine sets 110, 122.

Storage 144 may include a mass media device operable to store any type of information that CPU 141 may use to perform processes associated with environmental monitoring system 140. Storage 144 may include one or more magnetic or optical disk devices, such as hard drives, CD-ROMs, DVD-ROMs, or any other type of mass media device.

Database 145 may include one or more memory devices that store, organize, sort, filter, and/or arrange data used by environmental monitoring system 140 and/or CPU 141. For example, database 145 may store historical environmental data associated with a job site of machine environment 100. Database 145 may also store current weather forecast information related to each job site associated with machine environment 100. Database 145 may also store operational parameters for each component or system of components associated with machine 100, including operating ranges for the components, threshold levels, etc.

Input/Output (I/O) devices 146 may include one or more devices operable to communicate with systems or networks external to machine 100 such as, for example, the Internet, one or more computer systems, a communication network, a PCS network, or any other suitable network. I/O devices 146 may include one or more communication devices, such as a network card, a wireless transceiver, or any other device for providing a communication interface between environmental monitoring system 140 and an external component.

Interface 147 may include hardware and/or software components that allow a user to access information stored in environmental monitoring system 140. For example, environmental monitoring system 140 may include a data access interface that includes a graphical user interface (GUI) that allows external users to access, configure, store, and/or download information to off-board systems, such as computers, PDAs, diagnostic tools, or any other type of data device. Moreover, interface 147 may allow a user to access and/or modify information, such as operational parameters, operating ranges, and/or threshold levels associated with one or more component configurations, stored in database 145.

Environmental monitoring system 140 may include one or more computer systems of a business entity associated with machine environment 100 such as a project management division, a maintenance division, an operations division, a payroll division, a personnel division, and any other entity that monitors, maintains, operates, schedules, and/or manages machine environment

Environmental monitoring system 140 may include any type of computer system such as, for example, a work station, a personal digital assistant (PDA), a mainframe, a network of computer systems, a laptop, and any other type of computer system or computer system network.

Environmental monitoring system 140 may be configured to receive operation data associated with one or more machines 120. Operation data may include one or more characteristics associated with an operation of machine 120. For example, operation data may include data reflecting one or more parameters associated with the operation of one or more of machines 120, such as, for example, status data (e.g., engine on/off, parked, stationary, etc.), load weight, engine speed, traction data, engine temperature, oil pressure, location, engine hours, tire wear, component fatigue, fluid levels, pressure data, machine position information, and any other parameter associated with the operation of a machine. In addition to parameters associated with an operation of a machine, operation data may also include data derived from operational parameters associated with a machine.

Environmental monitoring system 140 may also be configured to receive environmental data associated with work environment 100 from one or more machines 120. Environmental data may include one or more environmental characteristics associated with machine environment 100 such as, for example, air temperature, humidity, soil moisture level, wind speed, barometric pressure, precipitation, heat index, UV radiation, or any other environmental aspect associated with machine environment 100.

Environmental monitoring system 140 may be further configured determine one or more environmental conditions associated with one or more job sites of machine environment 100 based on environmental and/or operational data received from one or more machines 120. For purposes of the present disclosure, environmental conditions may include one or more calculated, predicted, and/or observed parameters associated with machine environment 100 such as, for example, soil moisture level, terrain traction information, precipitation level and type, air quality index, relative humidity, predicted weather events (e.g., thunderstorms, windstorms, etc.), or any other type of environmental condition. Environmental management system 140 may determine these environmental conditions directly (e.g., using sensors that measure the desired parameter) or indirectly (e.g., using one or more sensors, combinations of sensors, or information derived from other appropriate sources).

Environmental monitoring system 140 may also indirectly determine soil characteristics using operation data it receives from one or more machines 120. This data may include, for example, transmission slip and engine torque associated with one or more machines 120 associated with machine set 110. From this data, environmental monitoring system 140 may determine that the soil quality in or around the work site associated with machine set 110 may not be suitable for performing certain tasks associated with machine environment 100.

Environmental monitoring system 140 may also be configured to determine the environmental conditions associated with one or more job sites by comparing environmental data associated with a particular job site with historical environmental data and/or weather forecast information associated with the job site stored in database 145. For example, environmental monitoring system 140 may determine that a particular set of environmental conditions (e.g., humidity, barometric pressure, air quality index, etc.) correspond to a weather event that previously prevented work at a particular job site based on historical environmental data stored in database 145.

Environmental monitoring system 140 may also be configured to update a project schedule based on the environmental conditions associated with one or more job sites of machine environment 100. For example, environmental monitoring system 140 may determine that a soil moisture level associated with a particular job site presents a non-ideal work condition at the job site. Accordingly, environmental monitoring system 140 may re-assign one or more machines 120 associated with that job site to an alternate site.

Environmental monitoring system 140 may also be configured to provide real-time information to an operator of one or more machines 120. Real-time information may include operating instructions such as, a work assignment, an operating schedule, shift information, a maintenance schedule, job site data (e.g., a topographical profile, a precipitation profile indicating areas of precipitation within the job site, a soil quality profile indicting quality of soil associated with an area of a job site, etc.) or any other type of information. Environmental monitoring system 140 may provide the information to the operator via a console associated with one or more machines 120.

According to one embodiment, environmental monitoring system 140 may also be configured to determine a productivity factor associated with one or more machines 120 based on environmental conditions associated with a respective machine. For example, environmental monitoring system 140 may determine that a machine operating in particular environmental conditions may only be 60% productive based on historical data stored in database 145. Although the productivity factor is described as a percent value, it is contemplated that the productivity factor may include any value indicative of a level of productivity corresponding with environmental conditions associated with each respective machine, such as a numerical index.

Environmental monitoring system 140 may be configured to compare the productivity factor associated with environmental conditions at a first job site and a prospective productivity factor associated with environmental conditions at an alternate job site and update the project schedule accordingly. For example, a first machine operating at a first job site may be operating at a productivity factor of 60% due to one or more non-ideal environmental conditions, while a second machine operating at a second job site may be operating at a productivity factor of 95%. Environmental monitoring system 140 may re-schedule the first machine to operate at the second job site for a predetermined period of time (e.g., for the next work shift, for one day, until the environmental conditions improve, etc.)

According to another exemplary embodiment, environmental monitoring system 140 may be configured to predict an amount of wear associated with a machine component and/or subsystem based on the environmental conditions associated with a job site. For instance, environmental monitoring system 140 may collect environmental and/or operation data indicating that machine 120 has been operating in extremely cold temperatures, which may lead to premature engine wear, particularly for engine components during cold-start conditions. Environmental monitoring system 140 may determine, using historical operation and/or maintenance data, a wear rate associated with a machine (and/or components thereof) operating in similar conditions, and modify a maintenance/repair schedule accordingly. In another exemplary embodiment, environmental monitoring system 140 may determine, through the analysis of environmental and/or operation data, that an environmental condition at a particular job site includes extremely moist, salty air quality. Environmental monitoring system 140 may determine, using historical data stored in database 145, a wear rate associated with certain components in this type of environment. Environmental monitoring system 140 may modify a machine maintenance/repair schedule, based on the determined wear rate. It is contemplated that, in addition to maintenance schedule modification, additional action may be initiated by environmental monitoring system 140 such as, for example, providing a operational checklist to a machine operator to manually inspect certain problem areas prior to each operation of the machine, generating a wear report (including historical wear data) for the machine, requesting custom modification to a machine operating in severe environmental conditions to provide protection against abnormal and/or accelerated wear, and/or any other appropriate action to decrease the effects or premature component and/or machine wear.

In addition to modifying a maintenance schedule according to environmental conditions, environmental monitoring system 140 may determine a residual value associated with a machine operating in certain environmental conditions. For example, if a machine is operating in harsh environments (e.g., environments requiring increased maintenance, exhibiting higher than normal wear rates, realizing increased incidents of component failure, etc.), environmental monitoring system 140 may determine a residual value of the machine and/or machine activity based on costs associated with operating the machine in these environments. Environmental monitoring system 140 may provide this information to a business entity (e.g., owner, leasing company, project manager, etc.) for estimating project overhead costs, determining premium pricing for leased machines, and/or determining a depreciation schedule for tax calculation. In one embodiment, environmental monitoring system 140 may calculate a lease term adjustment associated with a lease price based on machine wear resulting from one or more environmental conditions.

In another exemplary embodiment, environmental monitoring system 140 may be configured to remotely modify an operation of one or more machines 120 based on the determined environmental conditions. For example, if environmental data associated with a particular machine indicates that the machine is operating in extremely low pressure environments (typical of higher altitude operation), environmental monitoring system 140 may adjust an engine operation (e.g., modify an air/fuel mixture, adjust a regeneration system parameter, etc.) to keep the engine operating an appropriate efficiency level.

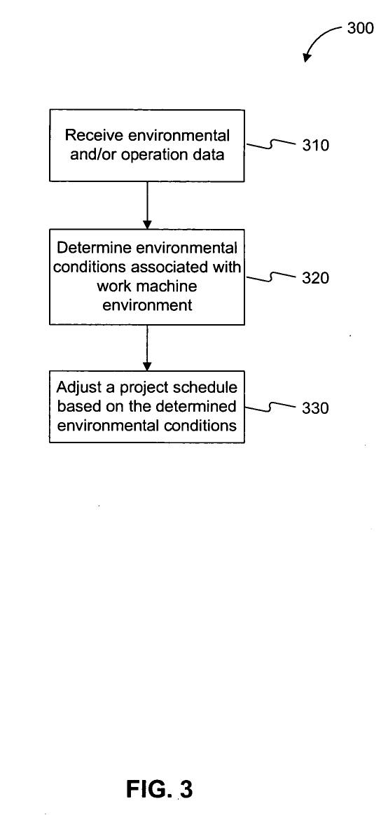

Methods and systems consistent with the disclosed embodiments may provide a work environment that determines, based on environmental and/or operation data received from one or more machines operating within the environment, one or more environmental conditions associated with the environment and updates a project schedule based on real-time data received from the machines. FIG. 3 illustrates a flowchart 300 depicting an exemplary method for managing a project environment. As illustrated in FIG. 3, environmental monitoring system 140 may receive environmental and/or operation data associated with one or more machines 120 operating within machine environment 100 (Step 310). For example, environmental monitoring system 140 may broadcast a data request to each of machines 120 over communication network 130 and receive the data in response to the request. Alternatively and/or additionally, each of machines 120 may automatically transmit environmental and/or operation data to environmental monitoring system 140 via communication network 130.

Upon receiving environmental and/or operation data, environmental monitoring system 140 may determine one or more environmental conditions associated with the received data (Step 320). For example, environmental monitoring system 140 may determine the environmental conditions based on one or more sensor outputs such as temperature, air pressure, soil moisture, etc. Alternatively and/or additionally, environmental monitoring system 140 may compare the environmental data with historical data associated with a particular machine and/or weather forecast data of a job site associated with the machine and derive the environmental conditions from the received environmental data. Alternatively and/or additionally, environmental monitoring system 140 may determine the environmental conditions associated with the machine based on the received operation data. For example, environmental monitoring system 140 may be configured to calculate a soil moisture content based on a traction data received from the machine.

Environmental monitoring system 140 may generate and/or update a project schedule based on the environmental conditions (Step 330). For example, environmental monitoring system 140 may determine that the environmental conditions associated with a particular job site may prevent certain activities from being conducted at that site. Accordingly, environmental management system 140 may update the project schedule to postpone, cancel, and/or reschedule those activities at that job site. Alternatively and/or additionally, one or more machines 120 which may be dedicated to performing those activities at the job site may be redirected to a nearby job site with environmental conditions permitting these activities.

According to one embodiment, environmental monitoring system 140 may be configured to provide the project-related information to one or more machines 120. For example, environmental monitoring system 120 may notify one or more operators 120 regarding changes in the project schedule associated with the respective machine. Alternatively and/or additionally, environmental monitoring system 140 may provide information relating to an operation of the machine, such as, for example, operating instructions, work assignments, environmental profiles associated with a particular job site, terrain data, soil moisture information, or any other type of project-related information.

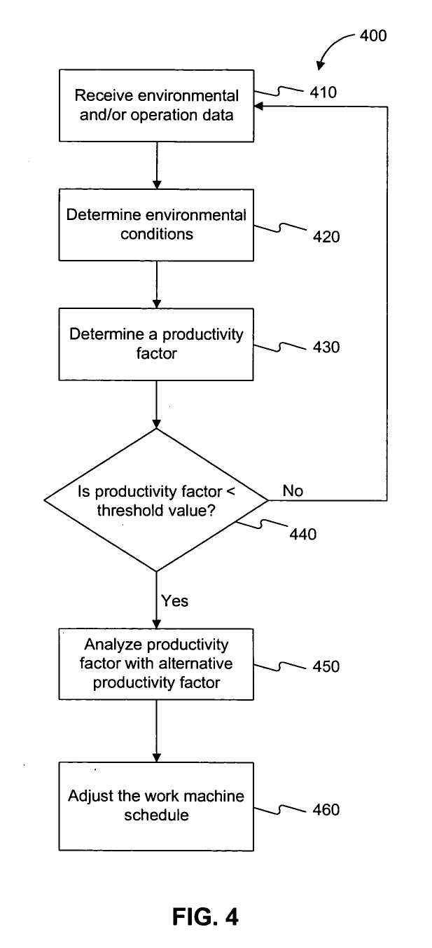

According to one embodiment, environmental monitoring system 140 may be configured to evaluate one or more work assignments for each machine 120 based on the environmental conditions at each job site and update a project schedule based on the evaluation. For example, as illustrated in flowchart 400 of FIG. 4, environmental monitoring system 140 may receive environmental and/or operation data as in step 310 of flowchart 300 (Step 410).

Upon receipt of the received data, environmental monitoring system 140 may determine the environmental conditions associated with machine 120 (Step 420). As previously explained, environmental monitoring system 140 may determine one or more environmental conditions of a job site based on environmental parameters (e.g., air temperature, barometric pressure, humidity level, wind speed, etc.) received from monitoring devices 121a-f. Alternatively and/or additionally, environmental monitoring system 140 may determine the environmental conditions based on operation data associated with machine 120.

Environmental monitoring system 140 may determine a productivity factor based on the determined environmental conditions (Step 430). For example, environmental monitoring system 140 may calculate a productivity factor of 40% associated with a particular machine operating at a particular job site based on the soil moisture conditions at the job site. Alternatively and/or additionally, environmental monitoring system 140 may determine that precipitation at a particular job site may prevent operation of machines at that site for the duration of the precipitation event, resulting in an assigned productivity factor of 0%.

If the determined productivity factor is less than a predetermined threshold level (Step 440; Yes), environmental monitoring system 140 may analyze the determined productivity factor with an alternative productivity factor (Step 450). The predetermined threshold level may include a productivity value established as an appropriate cost/benefit threshold associated with an operation of a particular machine and expressed as a value (such as a percentage (i.e., 80%)) that is easily comparable to the determined productivity factor. Accordingly, should the determined productivity factor be less than the threshold value, it may be advantageous for to operate the machine at a more productive job site (depending upon overhead costs associated with transporting the machine to the alternative site, productivity lost during transport, environmental forecast at the alternate job site, etc.). As part of the productivity analysis, environmental monitoring system 140 may compare the productivity of machine at each alternate job site (including costs overhead costs) with the productivity factor of the current job site. For example, environmental monitoring system 140 may determine that a machine operating at a productivity factor of 40% at job site “A”may operate at a productivity factor of 95% at job site “B” with minimal overhead costs associated with the relocation. Accordingly, environmental monitoring system 140 may adjust the machine schedule accordingly (Step 460).

According to another embodiment, environmental monitoring system 140 may be configured to execute software that performs real-time cost analysis associated with environmental conditions at each job site, based on data collected by machines 120. For example, environmental monitoring system 140 may estimate the productivity of a particular machine at each job site associated with machine environment 100. Environmental monitoring system 140 may also include overhead costs associated with transport of the machine to each respective site. Environmental monitoring system 140 may automatically update the project schedule based on the this cost-analysis.

Although the exemplary method described above has been described as being performed by environmental monitoring system 140, it is contemplated that different and/or additional devices may perform the method. Alternatively and/or additionally, the method may be implemented manually, by one or more software programs as part of a computer system, or using any combination of manual, software, and/or hardware configuration suitable to perform the method.

### INDUSTRIAL APPLICABILITY

Although the disclosed embodiments are described in connection with machine environment 100, the disclosed environmental monitoring system and associated method may be applicable to any environment where it may be desirable to manage a project based on one or more environmental conditions. Specifically, the disclosed environmental monitoring system may determine environmental conditions of a job site based on environmental and/or operation data associated with a machine.

The presently disclosed environmental monitoring system 140 may provide several advantages over conventional monitoring systems. For example, environmental monitoring system 140 may be configured to determine environmental parameters from real-time or archived operation data associated with a machine operating at a particular job site. Thus, environmental monitoring system 140 may be configured to account for certain conditions (e.g., terrain conditions, soil moisture content, precipitation level and type, temperature, altitude, air quality, humidity level, etc.) which may not be available simply through analysis of weather forecast data.

In addition, environmental monitoring system 140 may provide increased weather forecast reliability. For example, because environmental monitoring system may rely on real-time data received from one or more machines, as opposed to open-source forecast information, actual environmental conditions may be monitored and/or calculated. This real-time integration of monitored data may provide a more effective and reliable method for determining weather conditions at a job site, particularly one that experiences rapidly changing weather patterns where forecast data may quickly become outdated.

Furthermore, environmental monitoring system 140 may improve the overall efficiency of machine environment 100. For example, rather than simply determining the weather conditions associated with a particular job site, environmental monitoring system 140 may calculate a productivity of a machine at multiple job sites and modify a project schedule accordingly. Thus, environmental monitoring system 140 may modify the project schedule and/or determine work assignments based on environmental conditions at each job site in order to maximize the overall productivity of machine environment 100.

It will be apparent to those skilled in the art that various modifications and variations can be made to the disclosed environmental monitoring system and method without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for managing a machine environment based on environmental conditions associated with a machine; comprising:
receiving one or more of environmental data and operation data associated with at least one machine operating at a job site associated with a machine environment;
determining one or more environmental conditions associated with the job site based on at least one of the environmental data and the operation data; and
updating a project schedule based on the determined environmental conditions.

2. The method of claim 1, wherein the environmental data includes at least one of an air temperature, a humidity level, a soil moisture level, and a wind speed.

3. The method of claim 1, wherein the operation data includes one or more of an engine speed, a torque output, a fuel consumption rate, and a transmission ratio associated with the machine.

4. The method of claim 1, wherein determining one or more environmental conditions corresponding to the at least one machine includes:
comparing the received environmental data with at least one of historical environmental data and weather forecast data.

5. The method of claim 1, wherein updating the project schedule includes:
determining a productivity factor associated with the determined environmental conditions based on one or more of the received environmental data, the received operation data, and historical productivity data;
comparing the determined productivity factor associated with the machine with an alternative productivity factor associated with an alternate job site; and
assigning the machine to the alternate job site if the determined productivity factor is substantially less than the alternative productivity factor.

6. The method of claim 1, wherein updating the project schedule includes providing a work assignment to an operator of the machine.

7. The method of claim 6, wherein the work assignment includes instructions for reporting to an alternate job site.

8. The method of claim 1, wherein updating the project schedule includes providing a precipitation profile associated with the job site to an operator of the machine.

9. The method of claim 1, further including estimating a wear rate of one or more machine components based on the one or more environmental conditions.

10. The method of claim 9, wherein estimating the wear rate includes determining a lease price adjustment based on the wear rate associated with one or more environmental conditions.

11. The method of claim 9, wherein estimating the wear rate includes calculating a residual value of the machine based on historical data.

12. The method of claim 1, further including adjusting an operational aspect of the machine based on the one or more environmental conditions.

13. A computer readable medium for use on a computer system, the computer readable medium having computer executable instructions for performing a method comprising:
receiving one or more of environmental data and operation data associated with at least one machine operating at a job site associated with a machine environment;
determining one or more environmental conditions associated with the job site based on at least one of the environmental data and the operation data; and
updating a project schedule based on the determined environmental conditions.

14. The computer readable medium of claim 13, wherein the environmental data includes at least one of an air temperature, a humidity level, a soil moisture level, and a wind speed.

15. The computer readable medium of claim 13, wherein the operation data includes one or more of an engine speed, a torque output, a fuel consumption rate, and a transmission ratio associated with the machine.

16. The computer readable medium of claim 13, wherein determining one or more environmental conditions corresponding to the at least one machine includes:
comparing the received environmental data with at least one of historical environmental data and weather forecast data.

17. The computer readable medium of claim 13, wherein updating the project schedule includes:
determining a productivity factor associated with the determined environmental conditions based on one or more of the received environmental data, the received operation data, and historical productivity data;
comparing the determined productivity factor associated with the machine with an alternative productivity factor associated with an alternate job site; and
assigning the machine to the alternate job site if the determined productivity factor is substantially less than the alternative productivity factor.

18. The computer readable medium of claim 13, wherein updating the project schedule includes providing a work assignment to an operator of the machine.

19. The computer readable medium of claim 18, wherein the work assignment includes instructions for reporting to an alternate job site.

20. The computer readable medium of claim 13, wherein updating the project schedule includes providing a precipitation profile associated with the job site to an operator of the machine.

21. The computer readable medium of claim 13, further including estimating a wear rate of one or more machine components based on the one or more environmental conditions.

22. The computer readable medium of claim 21, wherein estimating the wear rate includes determining a lease price adjustment based on the wear rate associated with one or more environmental conditions.

23. The computer readable medium of claim 21, wherein estimating the wear rate includes calculating a residual value of the machine based on historical data.

24. The computer readable medium of claim 13, further including adjusting an operational aspect of the machine based on the one or more environmental conditions.

25. A machine environment, comprising:
at least one machine for performing a task associated with the machine environment and including one or more monitoring devices configured to collect data indicative of at least one of environmental data and operation data associated with the at least one machine;
an environmental monitoring system communicatively coupled to the one or more machines via a communication network, the environmental monitoring system comprising:
a processor configured to:
receive one or more of environmental data and operation data associated with at least one machine operating at a job site associated with a machine environment;
determine one or more environmental conditions associated with the job site based on at least one of the environmental data and the operation data; and
update a project schedule based on the determined environmental conditions.

26. The machine environment of claim 25, wherein the environmental data includes at least one of an air temperature, a humidity level, a soil moisture level, and a wind speed.

27. The machine environment of claim 25, wherein the operation data includes one or more of an engine speed, a torque output, a fuel consumption rate, and a transmission ratio associated with the machine.

28. The machine environment of claim 25, wherein determining one or more environmental conditions corresponding to the at least one machine includes:
comparing the received environmental data with at least one of historical environmental data and weather forecast data.

29. The machine environment of claim 25, wherein updating the project schedule includes:
determining a productivity factor associated with the determined environmental conditions based on one or more of the received environmental data, the received operation data, and historical productivity data;
comparing the determined productivity factor associated with the machine with an alternative productivity factor associated with an alternate job site; and
assigning the machine to the alternate job site if the determined productivity factor is substantially less than the alternative productivity factor.

30. The machine environment of claim 25, wherein updating the project schedule includes providing a work assignment to an operator of the machine.

31. The machine environment of claim 30, wherein the work assignment includes instructions for reporting to an alternate job site.

32. The machine environment of claim 25, wherein updating the project schedule includes providing a precipitation profile associated with the job site to an operator of the machine.

33. The machine environment of claim 25, further including estimating a wear rate of one or more machine components based on the one or more environmental conditions.

34. The machine environment of claim 33, wherein estimating the wear rate includes determining a lease price adjustment based on the wear rate associated with one or more environmental conditions.

35. The machine environment of claim 33, wherein estimating the wear rate includes calculating a residual value of the machine based on historical data.

36. The machine environment of claim 25, further including adjusting an operational aspect of the machine based on the one or more environmental conditions.
